(19) United States
(12) Patent Application Publication
(10) Pub. No.: US 2016/0098756 A1
(43) Pub. Date: Apr. 7, 2016

(54) DEVICE AND SYSTEM FOR DISPLAYING ADVERTISING

(71) Applicant: EMOTOVATE PTY LTD, New South Wales (AU)

(72) Inventor: Peter Ayre, New South Wales (AU)

(21) Appl. No.: 14/892,046

(22) PCT Filed: May 19, 2014
(86) PCT No.: PCT/AU2014/000523

§ 371 Date: Nov. 18, 2015

(30) Foreign Application Priority Data
Jun. 3, 2013 (AU) 2013901983
Aug. 2, 2013 (AU) 2013902892

(51) Int. Cl. G06Q 30/02; G01S 19/13

(52) U.S. Cl. CPC G06Q 30/0266; G06Q 30/0267; G01S 19/13

(57) ABSTRACT

A device adapted for displaying advertisements on vehicles, wherein the device comprises: a CPU connected to a memory circuit, a display panel mounted on the vehicle, a wireless transceiver, and GPS module, and wherein the advertisements are wirelessly transmitted to the wireless transceiver and stored in the memory circuit.

### TECHNICAL FIELD

The present invention relates to a device and system for displaying advertising or other information. More specifically, the invention may be adapted for use with motor vehicles to display advertising or other information on an outer surface of the motor vehicle.

### BACKGROUND

Previously, there have been many methods, devices and system for advertising businesses to the general public. A traditional form of advertising is the billboard wherein a static image or message is displayed for the public to view the images or message.

Billboards have been improved to use monitor screens to display moving images or messages to the general public.

Also static billboards have been mounted on vehicles to display messages and images promoting businesses to the general public. However, it was typically difficult for an advertiser or business to gauge the success of these types of marketing campaigns.

An improved advertising system is described in Published US Patent Application No. 2012/0323648. In this publication, the inventor describes an advertising system for mounting on a vehicle, wherein the advertising system forms an actuated billboard displaying a advertising message on a vehicle. The system is connected to a GPS signal transmitter, GPS receiver/locator and a microprocessor. The system displays images based on the location of vehicle. The system has very limited interoperability with other modern computer systems; and all of advertising messages must be pre-loaded into the microprocessor and are stored within the microprocessor. This is a significant disadvantage to usability of the system.

Any discussion of the prior art throughout the specification should in no way be considered as an admission that such prior art is widely known or forms part of common general knowledge in the field.

### SUMMARY

### Problems to be Solved

Previous systems and devices generally experienced a lack of interoperability. The prior art systems displays images based on the location of vehicle. The system has very limited interoperability with other modern computer systems; and all of advertising messages must be pre-loaded into the microprocessor and are stored within the microprocessor. This is a significant disadvantage to usability of the system.

Further previous systems failed to track users or the locations at which the advertisements were displayed.

It is an object of the present invention to overcome or ameliorate at least one of the disadvantages of the prior art, or to provide a useful alternative. Other objectives of the present invention may be realised throughout this specification.

### Means for Solving the Problem

A first aspect of the present invention may relates to a device adapted for displaying advertisements on vehicles, wherein the device comprises: a CPU connected to a memory circuit, a display panel mounted on the vehicle, a wireless transceiver, and GPS module, and wherein the advertisements are wirelessly transmitted to the wireless transceiver and stored in the memory circuit. Preferably, the device stores GPS data and motion data acquired from the GPS module in the memory circuit.

The preferred device may be selectively adapted to connect to a server and wherein the device wirelessly transmits GPS data and motion data to the server.

The preferred advertisements may be transmitted from the server through the mobile phone data network and wherein the device is adapted to interface with a smart phone and receives the transmitted data.

Also preferably, the CPU, memory circuit, display panel and wireless transceiver are encapsulated within one housing; and the device may adapted to be mounted on the interior surface of a rear window of a vehicle by adhesive.

Preferably, the device may also include a battery module in electrical communication with the device and adapted to power the device, and photo electric cell wherein at least one photo electric cell is adapted to charge battery module when in device is exposed to light. Preferably, at least one photo electric cell is mounted on the perimeter of the display panel.

The device may also include an accelerometer adapted to detect the orientation of display panel.

A second aspect of the present invention may relates to a system adapted to display advertisements on vehicles, wherein the system includes the steps of: registering an advertiser through a web portal connected to the server and storing information relating to an advertisement; registering an vehicle owner through a web portal connected to the server and entering a vehicle profile; installing a device in a vehicle associated with the vehicle owner wherein the device is adapted to display advertisements on the vehicle; wherein the advertiser selects a vehicle profile for displaying advertisements and advertising requests are sent to vehicle owners meeting the selected vehicle profile; and downloading the advertisement to the device for display.

Preferably, the vehicle owner may reject advertising and this selection by the vehicle owner is stored on server. The server may wirelessly transmit advertising data to device wherein said advertising data includes electronic images or videos. The preferred device stores advertising data in a memory circuit.

Preferably, the device may store GPS data and motion data and transmits this data to the server.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a rear view of a motor vehicle adapted to use a first preferred embodiment of the present invention;

FIG. 2 is stylised flow chart of the various steps from a vehicle owner's perception to be included within the first preferred embodiment;

FIG. 3 is stylised flow chart of the various steps from an advertiser's perception to be included within the first preferred embodiment;

FIG. 4 is stylised flow chart of the various steps to be included within the first preferred embodiment;

FIG. 5 is schematic block diagram of the first preferred embodiment; and

FIG. 6 is schematic block diagram of the second preferred embodiment.

FIG. 7 depicts a two dimensional barcode for use with the a third preferred embodiment of the present invention;

FIG. 8 depicts a system diagram for use with the third preferred embodiment;

FIG. 9 depicts a further system diagram for use with a third preferred embodiment; and

FIG. 10 depicts a device for use with the third preferred embodiment.

### DESCRIPTION OF THE INVENTION

Preferred embodiments of the invention will now be described with reference to the accompanying drawings and non-limiting examples.

Preferred embodiments of the invention will now be described with reference to the accompanying drawings and non-limiting examples.

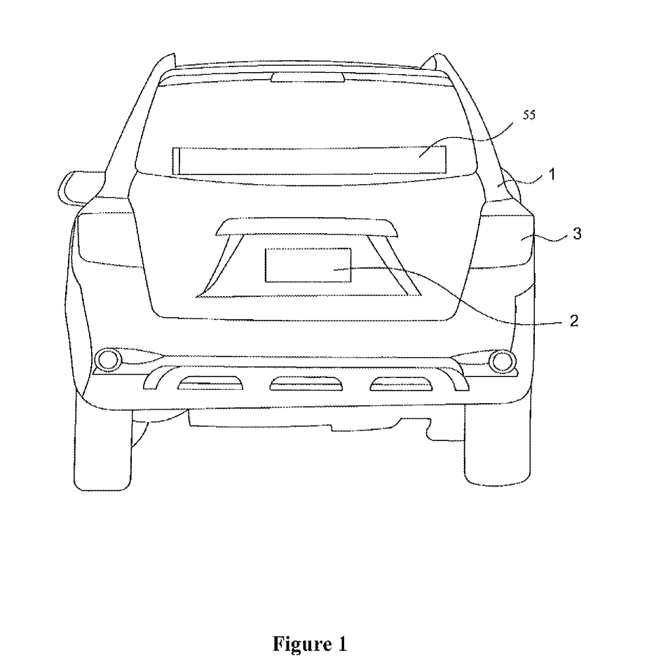

A first preferred embodiment of the present invention is depicted in FIGS. 1-5. The first preferred embodiment includes a device or system adapted for displaying advertisements or advertising on a vehicle or motor vehicle. More specifically, as shown in FIG. 1, the first preferred embodiment may be mounted on a rear of a vehicle 1. The license plate 2 has been removed from the image for interests of protecting personal information. A display panel 55 is mounted in the rear window of the vehicle 1 and is visible to people looking at the vehicle from the rear.

In other embodiments, the display panel 55 may be mounted on; either the sides of the vehicle, the rear of the vehicle; or the front of vehicle. The display panel 55 should positioned to maximise visual impact on people passing or entering visual range of the vehicle using the embodiment.

Preferably, the panel 55 may be adapted to be installed in the rear window of the vehicle. The display panel 55 may be a light weight monitor for displaying computerised images. The monitor may be constructed using LCD technology, OLED technology, e-ink technologies, or digital paper technologies. Preferably, the panel is light enough to allow the panel to be glued or stuck with adhesive to the interior surface of the rear window. Preferably, the panel may be deformable to match the contours of the window. The panel is adapted to display multiple computerised images or messages. The images may be static or in a video format. Preferably, the panel may display images in JPG, GIF, TIFF, PNG or other similar computerised standard form or videos in MPG, AVI, GIF animations, Flash™ animations, AAC, or DivX™ formats.

Preferably, panel 55 extends close to the width of the rear window of the vehicle with a width that is not sufficient to block or impede the field of vision of a driver of the vehicle when looking out the rear window.

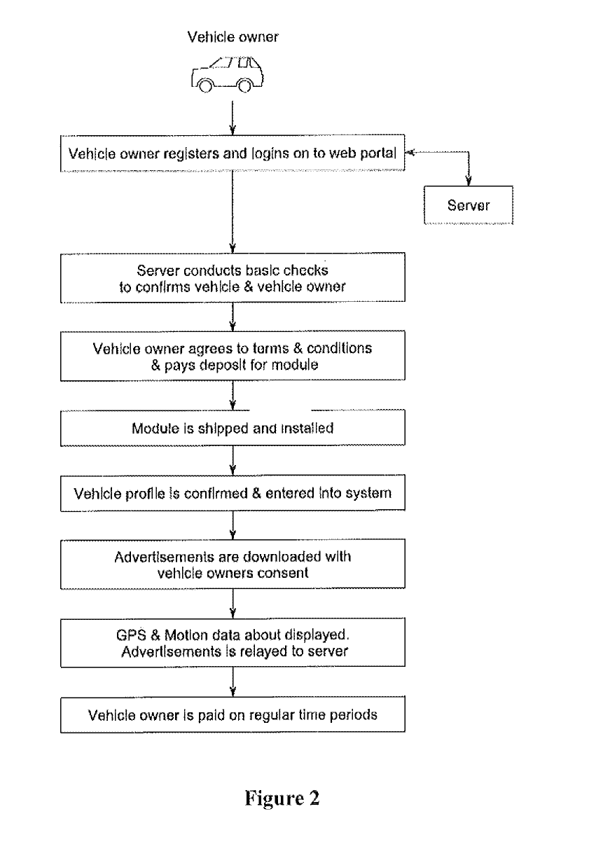

FIG. 2 depicts in a flow chart representation some of the steps that may form part of the first preferred embodiment of the present invention. The steps shown in FIG. 2 are the steps relevant to a Vehicle Owner and the system interactions with the Vehicle Owner. The first step is for the Vehicle Owner to either logon into a secure web portal. The web portal relays information to and from a connected server which may act a controller for some of the action of the system and stores information relating the Vehicle Owner choices and information.

After the login step has been completed, the server or system checks and confirms the details of the vehicle which is registered to the Vehicle Owner. The system may also check the contact details of the Vehicle Owner such as email and address details.

The Vehicle Owner is then requested to agree to some terms and conditions for using the system. Preferably, the terms and conditions relate to Vehicle Owner's consent to use personal information in the system and may selectively inform advertisers of some of the data collected through the system. Terms and conditions may also include payment terms for the Vehicle Owner. During this step or stage, the Vehicle Owner is requested to pay a deposit for an Ad Module to be sent to them and installed in the vehicle.

The Ad Module is then shipped to the Vehicle Owner and installed in the vehicle. The installation procedure may be collected by the Vehicle Owner or a trained professional.

After installation, the system receives data from either the installer or the Vehicle Owner confirming the Vehicle Profile. The Vehicle Profile designates the vehicle's type, make and classification. For example, compact, SUV, truck, sedan, taxi etc. The Vehicle Profile is stored on the server for later reference by the system and the advertiser. The Vehicle Profile may also include demographic data and algorithms for use by companies to select appropriate vehicles and cars for the display of their information or advertising.

Advertisement requests are then sent to Vehicle Owner via electronic messaging such as email, SMS text messaging, or other means. The Advertisement requests detail to the Vehicle Owner: the proposed advertiser, proposed monetary benefit to the Vehicle Owner and an image of the advertisement to be displayed. The Vehicle Owner may accept or decline the advertisement. Preferably, if no response is received by the server within 24 hours, the advertisement is automatically declined. This allows the Vehicle Owner to control the advertisements displayed on the panel 55. A Vehicle Owner may wish to decline advertisements that they do not agree with or endorse. Once the Vehicle Owner's consent is established, the advertisement is downloaded to the Ad Module which displays the advertisement on the panel 55.

Preferably, the Ad Module includes GPS tracking hardware and motion tracking hardware to allow the Ad Module to record data about the Vehicle and information about where and when the advertisements were displayed. Additionally, the Ad Module would only activate when the vehicle is active or alternatively when the vehicle is in motion. Time of advertisement displays, motion of vehicle and GPS data are relayed back to the server and stored on its database.

The Vehicle Owner is then automatically paid for level and amount of advertising based on their own motion data and GPS data. Further payments to the Vehicle Owners would be modified based on the level of incentive set by the advertiser. Some advertisements may require higher levels of incentives to encourage Vehicle Owners to display these advertisements. Preferably, payments would be issued to the Vehicle Owner on a regular time intervals such as weekly or monthly. Payments may be processed electronically and information about payments may be accessible through the web portal.

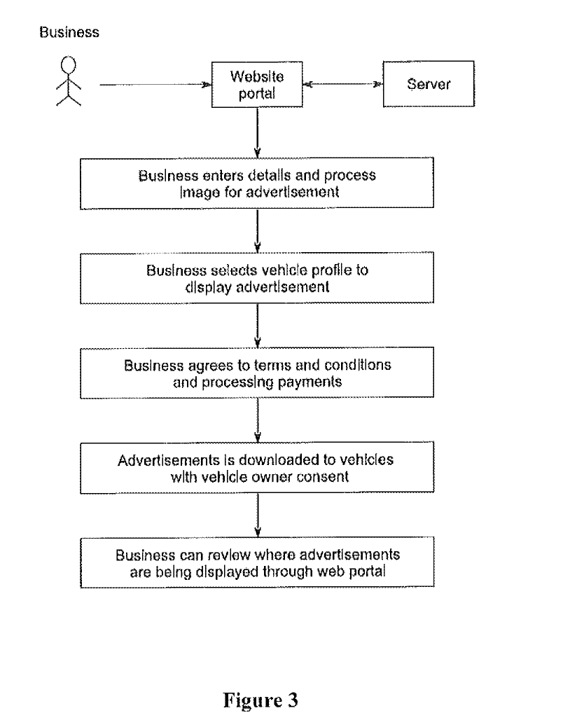

FIG. 3 depicts a further schematic view of a flowchart. This flowchart demonstrates some of the steps and stages forming part of the first preferred embodiment as shown from the perspective of the business owner or advertiser. In this embodiment, the business owner or advertiser is any person wishing to place an advertisement using the system.

FIG. 3 shows the advertiser logging in and registering through the web portal. This web portal is preferably connected the same server as described in relation to FIG. 2.

In the second step, the business or advertiser enters their details into the system. These details include: their name, physical address, email address, payment details. The advertiser is then requested to upload their advertisement. The advertisement may be any approved format. The web portal into which the images, videos or messages are uploaded may include an image or video formatter to alter the images or video to preferred format of the display panel 55. The web portal may amend: the video or image compression rates, change resolution of videos or images, and amend the sizing or format of the images and videos to adapt them for upload to the Ad Modules.

The advertiser then selects in the web portal which is the preferred vehicle profile to be targeted for the advertising campaign. It may be advantageous to only advertise on certain types of vehicles (e.g. taxis or buses only). The vehicle profile may also include geographic considerations for the advertising campaign. For example, the advertiser may only wish to advertise in Sydney, Australia.

The advertiser then agrees to standard terms and conditions relating to the advertisements and payments. The terms and conditions for the advertisers may limited to approved types of content (e.g. not promoting smoking, alcoholic beverages, or pornographic material). The advertiser also agrees to pay a budgeted amount for advertising and a portion of the money collected is redistributed to vehicle owners using the system.

The advertisements are then downloaded from the server, after processing and formatting, into the Ad Modules with the Vehicle Owners permission or consent (see description relating to FIG. 2).

The advertisements are displayed on the preferred vehicle profiles. Information relating to the display of advertisements is relayed to the server and retrievable by the advertiser through the web portal. Specifically, the advertiser may be able to view information relating to location, duration, timing, number of advertisements and the length of operation of the display panel. Preferably, the data and information is anonymised to a sufficient level to prevent identification of vehicle owners or their locations. Preferably, there may be a time delay in the data availability to advertisers to protect the personal information of vehicle owners.

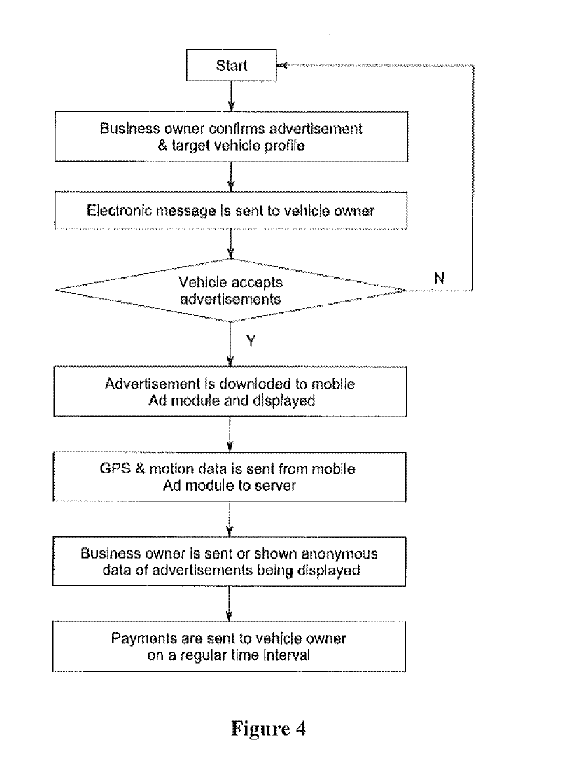

FIG. 4 shows a further schematic view of a flowchart showing some further steps and stages in respect to the first preferred embodiment.

The first step is to confirm the advertiser's details including address, email address, payment details, advertisement, and target vehicle profile. The system then automatically sends an electronic message to all possible vehicle owners meeting the desired or chosen vehicle profile.

The vehicle owners then individually approve or reject the advertising proposal based on the advertisement content and value. The approval process is achieved through the web portal connected to the server. If accepted, the advertisement is downloaded from the server onto the Ad Module and displayed on the panel display mounted in the vehicle. GPS and motion tracking data is collected by the Ad Module and sent to the server for collection, storage and collation. The advertiser is then sent or shown de-identified data relating to the displays of their advertisement and coverage of their advertising campaign. The system then sends payment to the vehicle owners chosen accounts and sends a confirmation notice to vehicle owner confirming payment.

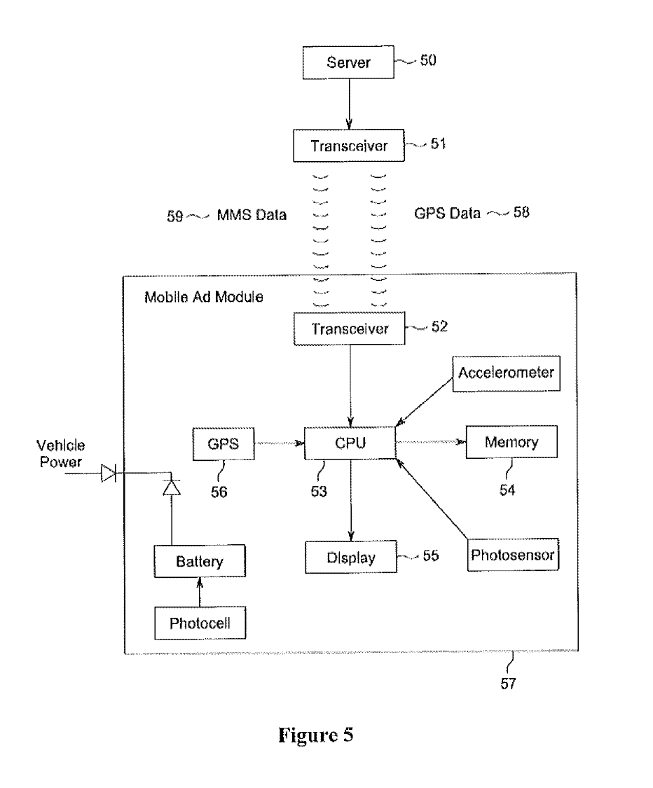

FIG. 5 depicts a block schematic breakdown of the parts including within the first preferred embodiment of the present invention. The server 50 may be positioned anywhere and is usually stored in safe and secure location on the premises of a service provider who administers the system. The server 50 is preferably connected to a first transceiver 51. This first transceiver 50 may include a wireless modem or router, but any system of wired or wireless transmission of data may allow for the data to be transmitted and received. The first transceiver is preferably positioned external relative to the vehicle 1.

In this figure, MMS data 59 is being sent from the first transceiver 51 to a second transceiver 52. Preferably, the MMS data may include video, images or text which forms part of the advertisement to be played or displayed on display panel 55. The MMS data may also include instructions to be interpreted by the CPU 53 about how and when the advertisement is to be displayed.

The Ad Module 57 preferably is mounted within the vehicle and may be formed within one encapsulated housing mounted on the interior rear window of a vehicle installed with the system. The Ad module 57 preferably includes: the second transceiver 52, CPU 53, memory 54, Global Positioning System (GPS) Module 56 and the display panel 55. The CPU 53 is adapted to coordinate the display of advertisements on the display panel 55 from advertisements stored and saves in memory 54. The CPU 53 also may adapt the displaying of advertisements based on data acquired from the GPS module 56. Data acquired from the GPS module 56 is saved in memory 54.

Preferably, the GPS module 56 may include GPS tracking hardware but may also include accelerometers for measuring the motion and direction of the vehicle.

The memory 54 is preferably large enough to store multiple advertisements and also store the GPS and motion data and time display data acquired from the CPU 53. Preferably, the memory may be flash technology inbuilt into the housing of the Ad Module to prevent tampering by the Vehicle Owner.

The CPU 53 then may employ the second transceiver 52 to upload GPS data 58, motion data, time data relating to the display of advertisements and the gross number of advertisements back to the server 50 via the first transceiver 51.

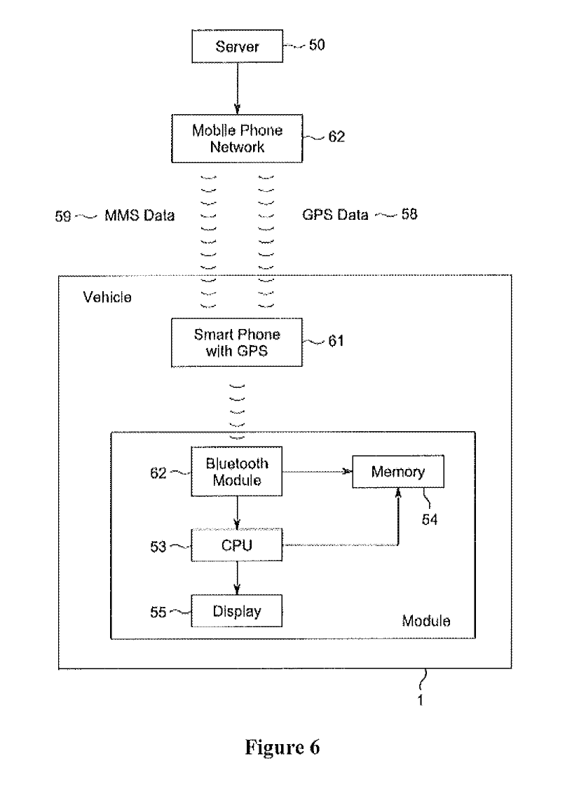

A second preferred embodiment of the present invention is depicted in FIG. 6. In FIG. 6, the first transceiver of the first preferred embodiment has been replaced with the server 50 being connected a mobile phone network 62. Primarily the server 50 is connected to a data network facilitating wireless transmission and receipt of data. The server may also be connected to the internet and then to the mobile phone network.

The second transceiver of the first preferred embodiment has been replaced with a smart phone 61 which acts as a conduit for the transmission of the data between the Ad Module 57 and the server 50. The Ad Module 57 has been modified so that it can utilise the GPS modules in built into smart phones. The Ad module 57 is also connected to the smartphone by a wireless protocol such as Wi-Fi™ or Bluetooth™.

Please note that in this specification, the term Vehicle Owner in this specification may be extended to mean any person with capacity to make decisions in relation to a motor vehicle and not necessarily the legal owner of the vehicle.

Preferably, the mounting of the devices and Ad Modules on the vehicles should be achieved in such a way so as to avoid messy wiring configurations or difficult installations. Wiring configurations wherein the Ad Module is wired into the brake light system of vehicle should be avoided to aid in easier installation and remove possible distractions of other drivers or people. Preferably, the Ad Module is wireless and only requires a power supply from the vehicle, which can be achieved through a cigarette lighter interface.

In the preferred embodiment shown in FIG. 5, the system or device forming the Ad Module 57 may also include a battery module and/or photocell. The battery module may be used to as stored power device to power the ad module 57 without the need for additionally power sourcing requirements. Preferably, the battery module may be rechargeable being constructed of NiMH or Li Ion although other rechargeable batterys may work. The battery module is preferably connected to all of the electrical components in the Ad Module 57. The battery module may be recharged automatically by the Vehicle's electrical power system.

Alternatively, the battery module may be charged by photo electric cells connected to the battery module. This may give the advantage of being a green power system so as to reduce the need for fossil fuel power being used to power the Ad Module. Preferably, the photo electric cells may be mounted around the external perimeter of the display panel 55 and be adapted to capture light energy to which the display panel is exposed to. Preferably, at least one photo electric cell may be used, but series of photo electric cells may be used to increase the power output necessary for relatively quickly charging the battery module.

Alternate embodiments of the present invention, may also include a photo sensor, photo detector or light sensor mounted within the Ad Module 57 as shown in FIG. 5. The photo sensor is preferably electrically connected to the CPU 53 and is adapted to be mounted within the housing of the Ad Module 57 so as to detect and monitor ambient light conditions to which the display panel 55 is exposed to. The light sensor may be used to vary the brightness of the panel display or additionally feedback more information to the server relating to the time of day and external conditions under which the advertising was being displayed.

Additionally, the Ad Module may include a visor or sun shield which may be a rigid protrusion extending horizontally from about or proximal to the top of display panel. This visor may be provided additional shade from the display panel to increase visibility during times of high levels of sunlight.

Preferably, the wireless interfaces and protocols used may include mobile phone protocols and these protocols may include GSM, Mobile Wifi™, 3G or 4G protocols. Alternatively, the functionality of the smartphone shown in FIG. 6 may be included within the housing of the Ad Module. In this configuration, each Ad Module may be assigned designated mobile phone number and advertising data may be sent directly to the Ad Module without the need for an external smartphone. The graphics and videos for the advertising may be sent via 3G or 4G networks.

Additionally, multiple advertisements may be displayed on a single Ad Module in a type of timesharing arrangement that allows for the rotation of advertising and that the Vehicle Owner may be paid for time that each advertisement is shown or displayed for.

Further embodiments of the present invention may also include accelerometers or motion detectors mounted in the controller housing. These accelerometers or motion detectors may detect the orientation of the display panel to which they are attached. Preferably, the CPU may be able to compensate for rotating the display and amend the image according to the changed dimensions of the rotated display panel. Further accelerometer or motion detector data may be feedback or relayed back to the server so that variant advertising could be displayed on the display panel. Preferably, the accelerometer may be mounted within the housing of the Ad Module and electrically connected to the CPU.

Further embodiments of the present invention may also include photo-sensors or light sensors. In FIG. 5, a photocell is shown as being housed within the Ad Module and may be preferably in electrical communication with the CPU. The photocell may detect the level of ambient light around the display panel and instruct the CPU. CPU may then alter the brightness and contrast of the display panel to compensate for the changes in ambient light levels. Further the CPU may record additional data in memory regarding time of day and light levels as this information may be important to relay to the server and the advertisers. Additionally, the photocell may allow the system to detect whether the display panel has been intentionally covered by the Vehicle Owner.

The preferred photo-sensor may also detect whether the display panel has been moved when the vehicle is not in operation. This may indicate to the CPU and system that the display panel has been removed from the vehicle and an alert message may be sent to the server or system operator.

A further improvement or variation to the above preferred embodiments may be to include in the Ad Module, an emergency override module. This emergency override module may be hardware or software that when engaged overrides the advertising or information being displayed by the display panel with an emergency message. This emergency override system could be selectively engaged by emergency service personnel in critical situations to warn road users of a disaster emergency.

In a further embodiments, the CPU of the Ad Module may detect the speed of the vehicle using motion detectors or GPS data and change advertising or messaging shown on the display panel to depict an advertising campaign wanting to advertise on a fast or slow moving vehicle.

Although the invention has been described with reference to specific examples, it will be appreciated by those skilled in the art that the invention may be embodied in many other forms, in keeping with the broad principles and the spirit of the invention described herein.

In further embodiments, the display panels may be modified in terms of their behaviours to better conform with local driving rules and regulations and also to decrease he likelihood of distraction caused to other road users. Primarily, one such modification may include the controller automatically reducing the brightness of the display panel to reduce the chance of distraction. The brightness reduction may be greater during times of night or low visibility.

A further modification may be to reduce the cycling rate of the advertisements shown on the display panel to a predetermined minimum level of advertisements per minute. This may also reduce to chance or likelihood of distraction to other persons viewing the display panel.

In a further embodiment, the display panels may be modified to be used in a retail environment such as a retail shop, bar, sporting club or shopping centre rather than mounted in or on a motor vehicle. These types of display panel may be of a larger size and shape as their size is not typically limited by size or weight limitations of a motor vehicle. The display panels may be mounted or positioned in preferred locations that are visible to potential customers.

The power source for display panels positioned or located in shops or shopping centres may include a battery which charged from the mains power or AC power supply.

Instead, of using Vehicle Profiles, this embodiment is modified to allow for selection of preferred Panel Location Profiles. These Panel Location Profiles may designate a type of retail shop or retail environment in which the display panel is located, geographic information, operating hours of the retail environment.

Additionally, in this embodiment all references to Vehicle Owners could be substituted for Display Panel Owners.

The controller of this embodiment may also include a forward facing camera. The camera and microprocessor may work in conjunction to determine and detect the number of people passing or viewing the display panel. The controller may be further improved to include a modification to detect and verify the motion of people viewed by the camera and thereby the controller may be able to determine the action of people viewing the display panel (e.g. the length of time they view the advertising for, whether the person viewing the display panel stops to read the advertising or whether the person viewing the panel increases speed to avoid looking at the panel). Preferably, standard recognition software could be used to identify people and their movements using integrated systems such as from Microsoft Xbox Kinect™. This data may be relayed by the controller back the website or website server for analyse by the person placing the advertisement.

Further, the controller may be able to display advertising on the panel that integrates images of detected people with the advertising displayed on the panel. Further the advertising may be able to interact with the person viewing the advertising. Information and data regarding the interaction may be relayed back to the website or web servers.

Preferably, the microprocessor contained within the controller of any of the aforementioned embodiments may include an LS641.0 Samsung™ ADM11 S3C6410 Board Kit TFT LCD Microprocessor. The specifications for this board and microprocessor are detailed at http://www.cutedigi.com/development-tools/arm11-development-platform/ls6410-samsung-arm11-s3c6410-board-kit-4-3-tft-led-android.html and are herein incorporated into this description.

The details of which have been reproduced as follows: S6410 development board was developed by LinkSprite™ (http://www.linksprite.com/). It consists of motherboard and core board.

LS6410 development board has the following features:
1. It uses highly integrated mature LS6410CORE board.
2. It has 24 bit RGB interface, and has connector for IIC, SPI and touch bus.
3. CVBS and TV output, all are after amplifier.
4. USB Host 1.1 interface.
5. USB OTG 2.0 interface.
6. RJ45 100M Ethernet interface with 1:1,414 transformer.
7. RS232 interface.
8. Connector for SPI, IIC, 4 channel ADC, 3 channel external interrupt, and two channel TTL UART, expect ADC, all can be used as 10 port.
9. SD card interface.
10. Cellphone keypad design
11. LED indicators.
12. Reset button
13. 1.5W speaker connector
14. MIC input circuit
15. Headphone connector (PJ-327)
16. Boot configuration switch
17. Connector for SIMCOM's GPRS SIM300 module.
18. PCB footprint for Sirf's GPS module.
19. SDIO WIFI interface: (with miniPCI interface)

The S3C6410X is a 16/32-bit RISC microprocessor, which is designed to provide a cost-effective, low-power capabilities, high performance Application Processor solution for mobile phones and general applications. To provide optimized H/W performance for the 2.5G & 3G communication services, the S3C6410X adopts 64/32-bit internal bus architecture. The 64/32-bit internal bus architecture is composed of AXI, AHB and APB buses. It also includes many powerful hardware accelerators for tasks such as motion video processing, audio processing, 2D graphics, display manipulation and scaling. An integrated Multi Format Codec (MFC) supports encoding and decoding of MPEG4/H.263/H.264 and decoding of VC1. This H/W Encoder/Decoder supports real-time video conferencing and TV out for both NTSC and PAL mode. Graphic 3D (hereinafter 3D Engine) is a 3D Graphics Hardware Accelerator which can accelerate OpenGL ES 1.1 & 2.0 rendering. This 3D Engine includes two programmable shaders: one vertex shader and one pixel shader.

The S3C6410X has an optimized interface to external memory. This optimized interface to external memory is capable of sustaining the high memory bandwidths required in high-end communication services. The memory system has dual external memory ports, DRAM and Flash/ROM. The DRAM port can be configured to support mobile DDR, DDR, mobile SDRAM and SDRAM. The Flash/ROM port supports NOR-Flash, NAND-Flash, OneNAND, CF and ROM type external memory.

To reduce total system cost and enhance overall functionality, the S3C6410X includes many hardware peripherals such as a Camera Interface, TFT 24-bit true color LCD controller, System Manager (power management & etc.), 4-channel UART, 32-channel DMA, 5-channel 32 bit Timers with 2PWM output, General Purpose I/O Ports, I2S-Bus interface, 12C-BUS interface, USB Host, USB OTG Device operating at high speed (480 Mbps), 3-channel SD/MMC Host Controller and PLLs for clock generation.

The ARM subsystem is based on the ARM1176JZF-S core. It includes separate 16 KB Instruction and 16 KB data caches, 16 KB Instruction and 16 KB Data TCM. It also includes a full MMU to handle virtual memory management.

The ARM1176JZF-S is a single chip MCU, which includes support for JAVA acceleration. The ARM1176JZF-S includes a dedicated vector floating point coprocessor allowing efficient implementation of various encryption schemes as well as high quality 3D graphics applications. The S3C6410X adopts the de-facto standard AMBA bus architecture. These powerful, industry standard features allow the S3C6410X to support many of the industry standard Operating Systems.

By providing a complete set of common system peripherals, the S3C6410X minimizes overall system costs and eliminates the need to configure additional components. The S3C6410X is implemented using an advanced 65nm CMOS process. The low-power, simple, elegant and fully static-design scheme is particularly suitable for cost sensitive and power-sensitive applications.

In alternate embodiments, the controller may include any or all of the following systems and improvements:

Inputs and Sensory Inputs
Moving or static Image with/without sound from Web source—GPRS—3G 4G , Wifi, Bluetooth or RF.
Motion—accelerometer 3D motion
Light sensor—to assess ambient light intensity.
Global position via GPS sensor
Camera or Infrared sensor or ultrasonic to detect how many people pass by or vehicles change behind the display for feedback to company.

Outputs
Sound and image static or moving—display types passive (OLED) and actively illuminated displays.

Power Sources
rechargeable battery,
AC,
Solar.

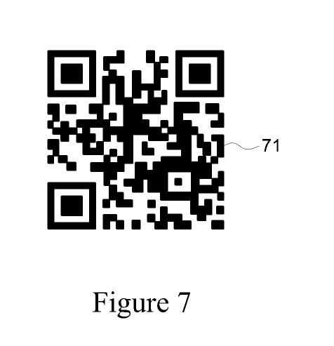

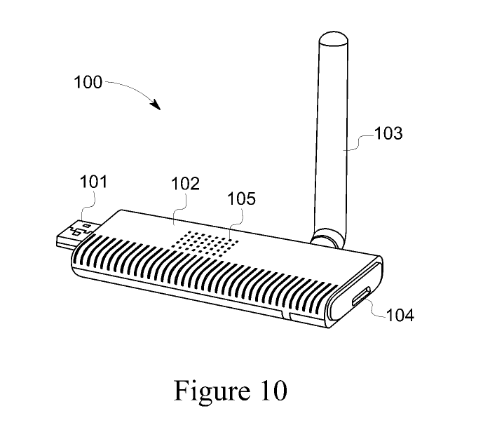

In a third preferred embodiment of the present invention, a system and a device as shown in FIGS. 7 to 10 to provide a device or system for displaying advertisements.

Preferably, the device or dongle 100 may be adapted to interface or electronically connect to a display device such as a display panel. The interface may be preferably a HDMI interface wherein the male connector 101 extends from one of the longitude ends of the dongle 100.

The dongle 100 may include a body 102 including airvents 105. The airvents may be mounted on any outer surface but is preferred that the airvents be mounted proximal to the position of the ICs or integrated circuits which are responsible for calculations wherein the device. The airvents may improve heat loss from the interior of the dongle 100.

The dongle 100 may also include an antenna 103 mounted preferably on a swivel arrangement to the body 102. The antenna may be used to relay WIFI™ or Bluetooth™ signals to the dongle 100. The opposed longitudinal end of the dongle 100 with respect to the male connector 101 may include a USB or Mini-USB interface 104 which may be adapted to connect to a further electronic device when connected.

The dongle 101 may also include a rechargeable battery which may be selectively charged by a power connection to the interface 104.

Preferably, the dongle 100 is adapted to be plugged into a HDMI slot of a display panel and receive electronic signals via the antenna 103. A power source may be connected to interface 104.

Preferably, the dongle 100 may include electronic components adapted to receive advertisements from an internet based advertising system and display them in the associated and connected display panel in a similar manner to the previous embodiments. Please note that dongle 100 preferably, includes the necessary codecs and decoding software to allow for the display of the advertisements. Also, the dongle may include the capacity to data log and include a GPS monitoring system.

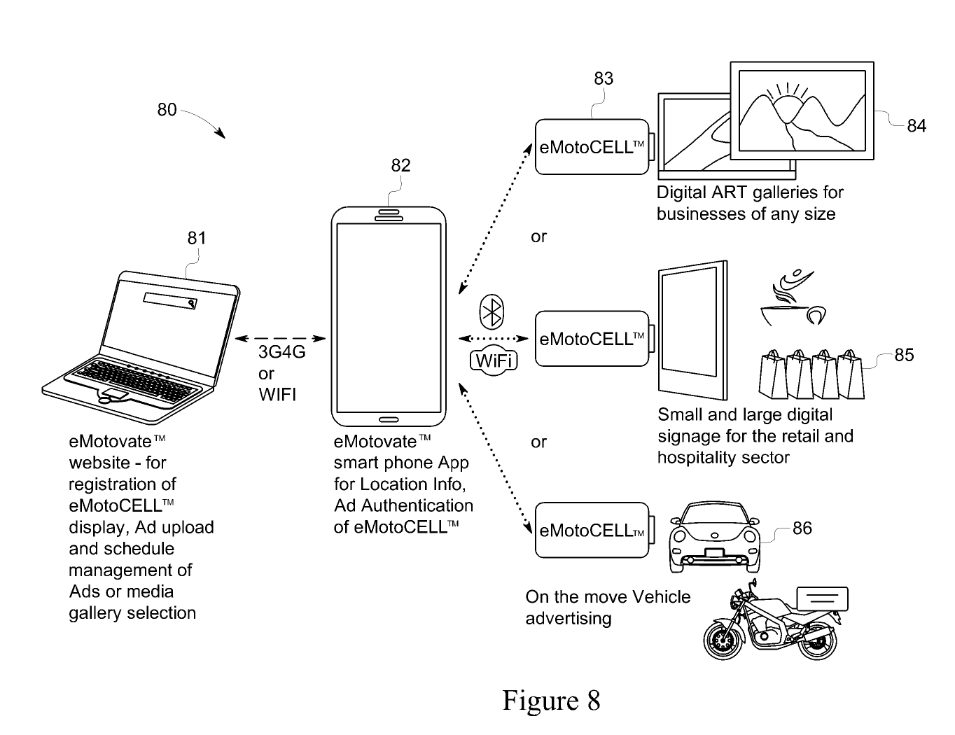

In FIG. 8, the dongle is represented by electronic module 83 which may be selectively plugged into selected display panels. In FIG. 8, the display panels include relatively large LCD or flat screen panels for use a digital art gallery 84; large flat panel electronic displays for use in hospitality or retail 85; or mounted on vehicles including flat screen panels mounted on cars, taxis, scooters or motorbikes 86.

Preferably, a user of the system may initiate the first step 81 and may register as a user of the website. In this example, it may be referred as to the eMotovate™ website. Users of the site are issued with a device 83, the device 83 is preferably linked to a user account and multiple devices 83 may be connected to a single user account.

The website and internet based server (not shown in FIG. 8) connected to the system may relay advertising or advertisements to a linked smart phone 82 which is preferably internet enabled. The smart phone 82 preferably then relays the advertisements to the dongle or device 83 for display on the display panel 84, 85 or 86.

The dongle may relay time, date, and operation logging information, GPS positional information to the smart phone 82 in a type of bi-direction Bluetooth™ or Wifi™ link.

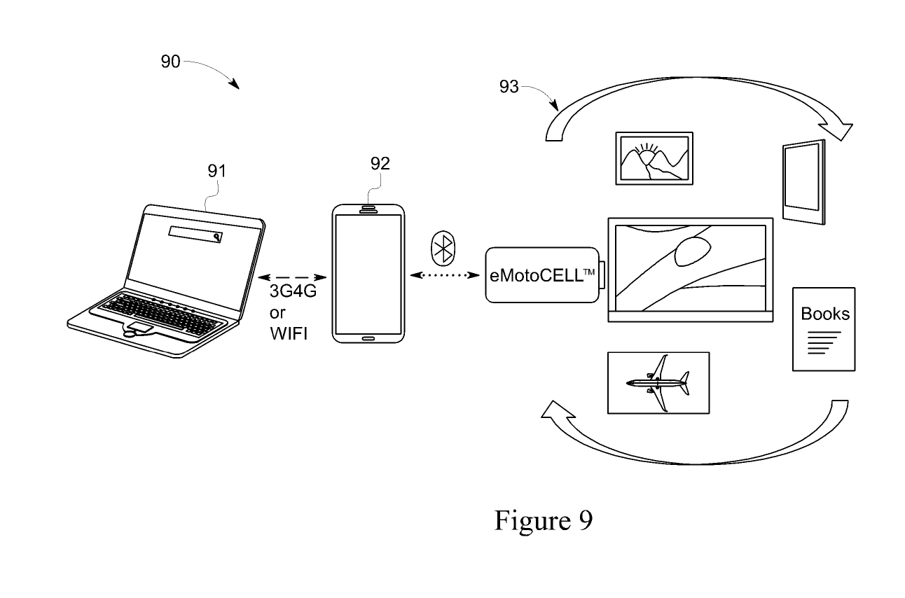

A more simplified version of the system 90 is depicted in FIG. 9, wherein the internet based system 91 or associated computer system is linked to a smart phone 92 which is turned linked to the dongle 100 which plugged into various types of display panel 93. The images shown in FIG. 9 at position 93 depict various types of advertising displayed on the display panels and these are shown for indicative purposes only.

Preferably, the smart phones used with the third preferred embodiment may be connected the internet system by the use of two dimensional (2D) barcode displayed on the computer screen of a computer connected to the web interface. When a user logins into the web based system, they may initiate the connection of a smart phone and the dongle 100. A 2D barcode 71 may be displayed on the computer screen and the smart phone may scan the barcode using its camera and associated application software. The application software running on the smart phone may authenticate the user details and the connection to the internet based server system.

Additionally, 2D barcodes similar to the one depicted in FIG. 7 may be shown or displayed on the aforementioned display panels wherein advertising is displayed. The 2D barcode may also form part of the advertising display. A third party user directing a smart phone camera towards the 2D barcode may be directed to a website of an associated website address encoded within the barcode. These types of 2D barcodes are sometimes referred to as QR codes.

Additionally, the system may utilise the GPS, time, date, and information recorded on the smart phone and relay this information to the internet based system for logging or data analysis purposes.

Although the invention has been described with reference to specific examples, it will be appreciated by those skilled in the art that the invention may be embodied in many other forms, in keeping with the broad principles and the spirit of the invention as described herein.

The present invention and the described preferred embodiments specifically include at least one feature that is industrial applicable.

What is claimed is:

1.-18. (canceled)

19. A device adapted for displaying advertisements on vehicles, wherein the device comprises: a CPU connected to a memory circuit, a display panel mounted on the vehicle, a wireless transceiver, and GPS module, and wherein the advertisements are wirelessly received by the wireless transceiver and stored in the memory circuit; and
wherein the wireless transceiver receives the advertisements from a smartphone and wherein the smartphone is adapted to receive the advertisements from a remote server using wireless communication protocols.

20. The device of claim 19, wherein the smartphone is adapted to act as a conduit for the transmission of data between the device and the remote server.

21. The device of claim 20, wherein the device stores GPS data and motion data acquired from the GPS module in the memory circuit.

22. The device of claim 21, wherein multiple advertisements are stored and displayed on the display panel.

23. The device of claim 22, wherein the device is selectively adapted to connect to a server and wherein the device wirelessly transmits GPS data and motion data to the server.

24. The device of claim 23, wherein the advertisements are transmitted from the server through the mobile phone data network and wherein the device is adapted to interface with a smart phone and receives the transmitted data.

25. The device of claim 24, wherein the CPU, memory circuit, display panel and wireless transceiver are encapsulated within the housing.

26. The device of claim 25, wherein the device is adapted to be mounted on the interior surface of a rear window of a vehicle by adhesive.

27. The device of claim 26, wherein the device includes a battery module in electrical communication with the device and adapted to power the device, and photo electric cell wherein at least one photo electric cell is adapted to charge battery module when in device is exposed to light.

28. The device of claim 27, wherein at least one photo electric cell is mounted on the perimeter of the display panel.

29. The device of claim 24, wherein the device includes an accelerometer adapted to detect the orientation of display panel.

30. The device of claim 24, wherein the GPS data or motion data used by the CPU to modify advertisements shown on the display panel.

31. A system adapted to display advertisements on vehicles, wherein the system includes the steps of:
a. Registering an advertiser through a web portal connected to the server and storing information relating to an advertisement;
b. Registering an vehicle owner through a web portal connected to the server and entering a vehicle profile;
c. Installing a device in a vehicle associated with the vehicle owner wherein the device is adapted to display advertisements on the vehicle;
d. Wherein the advertiser selects a vehicle profile for displaying advertisements and advertising request are sent to vehicle owners meeting the selected vehicle profile; and
e. Downloading the advertisement to the device for display from a smartphone, wherein the smartphone downloads the advertisement from a remote server using wireless communication protocols.

32. The system of claim 31, wherein the vehicle owner may reject advertising and this selection by the vehicle owner is stored on server.

33. The system of claim 32, wherein the server wirelessly transmits advertising data to device wherein said advertising data includes electronic images or videos.

34. The system of claim 33, wherein the said device stores advertising data in a memory circuit.

35. The system of claim 34, wherein the device stores GPS data and motion data and transmits this data to the server.

36. A system adapted to display advertisements on display panels, wherein the system includes the steps of:
a. Registering an advertiser through a web portal connected to the server and storing information relating to an advertisement;
b. Registering an display panel owner through a web portal connected to the server and entering a display panel profile;
c. Installing a device in a preferred location wherein the device is adapted to display advertisements;
d. Wherein the advertiser selects a vehicle profile for displaying advertisements and advertising request are sent to display panel owners meeting the selected display panel profile; and
e. Downloading the advertisement to the device for display from a smartphone, wherein the smartphone downloads the advertisement from a remote server using wireless communication protocols.

37. The system of claim 36, wherein the preferred location is selected from one of the following group: shop, retail environment, shopping centre, club, bar or motor vehicle.
